(19) United States
(12) Patent Application Publication
(10) Pub. No.: US 2011/0243052 A1
(43) Pub. Date: Oct. 6, 2011

(54) DYNAMIC RATE AND FEC ADAPTATION FOR VIDEO MULTICAST IN MULTI-RATE WIRELESS NETWORKS

(76) Inventors: Ozgu Alay, Brooklyn, NY (US); Thanasis Korakis, Brooklyn, NY (US); Shivendra S. Panwar, Freehold, NJ (US); Yao Wang, Livingston, NJ (US)

(21) Appl. No.: 12/753,544

(22) Filed: Apr. 2, 2010

(51) Int. Cl. H04H 40/00

(52) U.S. Cl. 370/312

(57) ABSTRACT

Video multicast over Wireless Local Area Networks (WLANs) faces many challenges due to varying channel conditions and limited bandwidth. A promising solution to this problem is the use of packet level Forward Error Correction (FEC) mechanisms. However, the adjustment of the FEC rate is not a trivial issue due to the dynamic wireless environment. This decision becomes more complicated if one considers the multi-rate capability of the existing wireless LAN technology. A novel method which dynamically adapts the transmission rate and FEC for video multicast over multi-rate wireless networks is described. In order to evaluate the system experimentally, a prototype using open source drivers and socket programming was implemented. Experimental results show that the proposed system significantly improves the multicast system performance.

### §0.1 RELATED APPLICATIONS

This application claims the benefit of U.S. Provisional Patent Application Ser. No. 61/166,405 (incorporated herein by reference and referred to as “the '405 provisional”), titled “DYNAMIC RATE AND FEC ADAPTATION FOR VIDEO MULTICAST IN MULTI-RATE WIRELESS NETWORKS” filed on Apr. 3, 2009, and listing Ozgu ALAY, Thanasis KORAKIS, Shivendra S. PANWAR and Yao WANG as the inventors. The present invention is not limited to requirements of the particular embodiments described in the '405 provisional.

### §0.0 GOVERNMENT RIGHTS

The United States Government may have certain rights in this invention pursuant to a grant awarded by the National Science Foundation. Specifically, the United States Government may have a paid-up license in this invention and the right in limited circumstances to require the patent owner to license others on reasonable terms as provided for by the terms of Award No. 0430885 awarded by the National Science Foundation (Division of Computer and Network Systems).

### §1. BACKGROUND OF THE INVENTION

1. Field of the Invention

The present invention concerns wireless communications. In particular, the present invention concerns wireless distribution of video content.

2. Background Information

In recent years, the demand for video applications over wireless networks has risen with the increase in both the bandwidth of wireless channels and the computational power of mobile devices. Multicasting is an effective solution for simultaneous transmission of data to a group of users, since it saves network resources by spreading the same data stream across multiple receivers. However, the high packet loss ratio and bandwidth variations of wireless channels make video multicast over wireless networks a challenging problem.

In a wireless network, as the external environment changes, the channel error rate varies, resulting in deleterious effects on multimedia transmission. In order to cope with errors and hence have robust video transmission, accurate channel-condition estimation and an effective error control mechanism is needed. Furthermore, due to bursty and location dependent errors, each user in a multicast system will most likely lose different packets. Therefore, a simple ARQ (Automatic Repeat reQuest) based scheme is not appropriate for video multicast over wireless channels since it can cause a large number of retransmissions.

There are several studies discussing error control in video multicast over wireless networks using forward error correction (FEC) to handle losses. (See, e.g., the articles: A. Basalamah, H. Sugimoto and T. Sato, “Rate adaptive reliable multicast MAC protocol for WLANs,” in Proceedings of IEEE VTC, 2006; C. Huang, J. H. David and C. Chang, “Congestion and Error Control for Layered Scalable Video Multicast over WiMAX,” in Proceedings of IEEE Mobile WiMAX Symposium, 2007; I. Bajic, “Efficient Error Control for Wireless Video Multicast,” Proceedings of IEEE MMSP, (2006); and H. Liu, M. Wu, D. Li, S. Mathur, K. Ramaswamy, L. Han and D. Raychaudhuri, “A Staggered FEC System for Seamless Handoff in Wireless LANs: Implementation Experience and Experimental Study,” in Proceedings of IEEE International Symposium on Multimedia, 2007, each of which is incorporated herein by reference.) In such systems, block erasure codes are used to correct errors using redundant information in the data stream. For example in an (n, k) block erasure code, there are a total of n packets where k of them are source packets and (n-k) of them are redundant parity packets. The parity packets are generated in such a way that any k of the n encoded packets are sufficient to reconstruct the k source packets. The advantage of using block erasure codes for multicasting is that a single parity packet can be used to correct independent single-packet losses among different receivers.

IEEE 802.11 wireless LANs (WLANs) are one of the fastest growing network technologies in the wireless communications field. The IEEE 802.11 Media Access Control (MAC) protocol provides a multirate-capable physical-layer. (See, e.g., LAN MAN Standards Committee of the IEEE Computer Society, ANSI/IEEE. Std 802.11, “Part 11: Wireless LAN Medium Access Control (MAC) and Physical Layer (PHY) Specifications: High-speed Physical Layer Extension in the 2.4 GHz Band,” IEEE 802.11 Standard, 1999, incorporated herein by reference.) The dynamic rate adaptation feature of IEEE 802.11 lets the transmitter adapt the transmission rate based on the wireless channel operating conditions which may vary with time. Some proposals for unicast communications have been reported in the literature to adapt the physical layer (“PHY”) data rate according to the channel conditions, such as ARF (Auto Rate Fallback) or REAR (Receiver Based Auto Rate) mechanisms. (See, e.g., the articles: A. Kamerman and L. Monteban, “WaveLAN II: A high-performance wireless LAN for the unlicensed band,” Bell Labs Technical Journal, pp. 118-133, 1997; and G. Holland, N. Vaidya, and P. Bahl, “A rate-adaptive MAC protocol for multi-hop wireless networks,” in Proceedings of ACM MOBICOM, July 2001, both incorporated herein by reference.) However, multicast/broadcast packets are always transmitted using the base transmission rate of the system (e.g., 1 Mbps for IEEE 802.11b). The intention of such a conservative approach is to minimize losses at the stations that are located far away from the transmitter, so that they are able to successfully receive and decode the packet.

The above rate adaptation mechanisms rely on the estimation of individual channel states, and therefore they cannot be directly applied to multicast service. The difficulty comes from the fact that the channel conditions between the Access Point (AP) and each receiver in the multicast group may differ, and in the absence of feedback the AP does not have any means to get to know the operating conditions of each individual receiver.

§1.2.1. Related Work

In A. Basalamah, H. Sugimoto, and T. Sato, “Rate adaptive reliable multicast MAC protocol for WLANs,” in Proceedings of IEEE VTC, May 2006 (incorporated herein by reference), a rate adaptive multicast scheme has been proposed where the transmitter must first send a Request to Send (RTS) frame to indicate the beginning of a multicast transmission. This RTS frame is used by all the multicast receivers to measure the Receiver Signal Strength (RSS). Then, each multicast receiver has to send a variable length dummy Clear to Send (CTS) frame with a length that depends on the selected PHY transmission mode. Finally, the transmitter senses the channel to measure the collision duration and can adapt the PHY rate transmission of the multicast data frame accordingly. In Y. Park, Y. Seok, N. Choi, Y. Choi, and J. M. Bonnin, “Rate-adaptive multimedia multicasting over IEEE 802.11 wireless LANs,” in Proceedings of IEEE CCNC, January 2006 (incorporated herein by reference), Signal to Noise Ratio (SNR)-based Auto Rate for Multicast (SARM) is proposed for multimedia streaming applications. In SARM, multicast receivers measure the SNR of periodically broadcasted beacon frames and transmit this information back to the AP. To minimize feedback collision, the back-off time for the transmission of feedback from each station increases linearly with the received SNR value. Then, the AP selects the lowest received SNR to determine the PHY rate transmission. Recently, a cross-layer approach for adaptive video multicast considering the multi-rate capabilities of wireless networks was studied. (See, e.g., J. Villalon, P. Cuenca, L. O. Barbosa, Y. Seok, and T. Turletti, “Cross-Layer Architecture for Adaptive Video Multicast Streaming Over Multirate Wireless LANs,” IEEE Transactions on Selected Areas in Communications, vol. 25, no. 4, May 2007 pp 699-711, incorporated herein by reference.) Their architecture requires knowing the operating conditions of the channel as perceived by the multicast members. The PHY data rate to be used for the multicast traffic is determined based on the feedback received by the AP. They also proposed using an H.264 hierarchical video coder in order to adapt the video transmission to the channel conditions perceived by the multicast receivers. Although the above algorithms seem to improve the performance of multicast in wireless networks by taking advantage of multi-rate capability, they do not make use of any error recovery mechanism. An exception is the mechanism in Villalon, et al. where the authors only employ data retransmission. However, such a mechanism is not a good fit for multicast. Furthermore, although these studies have shown the efficiency of rate adaptive multicast schemes via simulations, they do not provide insights on the way rate adaptation should be applied for multicast in a real wireless network. Limited implementation approaches in the literature focus on specific algorithms, and therefore they do not present a thorough investigation of the various trade-offs. Proxy-based adaptive FEC for reliable multicast in WLANs was studied in P. K. McKinley and A. P. Mani, “An experimental study of adaptive forward error correction for wireless collaborative computing”, in Proceedings of IEEE SAINT, 2001 (incorporated herein by reference). They proposed an adaptive FEC mechanism where the number of parity packets transmitted is based on the current data loss rate with a feedback system. The same group extended their studies to show that combining forward and backward error control is an effective strategy for proxy-based video multicast. (P. K. McKinley and A. P. Mani, “Experimental Evaluation of Error Control for Video Multicast”, in Proceedings of IEEE DCSW, 2001, incorporated herein by reference.) In both papers they evaluate the proposed schemes by implementing them in a real testbed. However, their studies considered only an indoor environment and fixed transmission rates (i.e., 2 Mbps and 11 Mbps).

### §2. SUMMARY OF THE INVENTION

Exemplary embodiments consistent with the present invention may provide a method or system for dynamically adapting the transmission rate and FEC rate in a multicast wireless network. The method may use, for example, the highest sustainable transmission rate together with a sufficient amount of FEC in order to maximize the video quality of multicast receivers. The proposed system may be implemented, for example, in the MAC layer as well as in the application layer, using open source drivers and socket programming, along with a packet level FEC implementation. Exemplary embodiments consistent with the claimed invention work efficiently in a real environment and significantly improve the performance of the network.

### §3. BRIEF DESCRIPTION OF THE DRAWINGS

FIG. 1 illustrates a wireless network in which exemplary embodiments consistent with the present invention may be used.

FIG. 2 is a flow diagram of an exemplary method for transmitting video information in a manner consistent with the present invention.

FIG. 3 illustrates experimental results showing Packet Error Rate (PER) and Useful Rate (Ruseful) versus Distance.

FIG. 4 illustrates an exemplary use of the Transmission Rate and FEC adaptation algorithm for determining transmission rates and FEC rate based on the packet error rate.

FIG. 5 illustrates simulations showing Peak Signal to Noise Ratio (PSNR) vs Frame Number for Experimental Scenario-I (Average PSNR for direct transmission and the proposed algorithm are 29.23 dB and 40.68 dB, respectively).

FIG. 6 illustrates simulations showing Peak Signal to Noise Ratio (PSNR) vs Frame Number with Direct Transmission for Experimental Scenario-II (Average PSNR of Client 1 & 2 and Client 3 are 28.31 dB and 27.88 dB, respectively).

FIG. 7 illustrates simulations showing Peak Signal to Noise Ratio (PSNR) vs Frame Number with Proposed Rate-FEC Adaptation for Experimental Scenario-II (Average PSNR of Client 1 & 2 and Client 3 are 36.59 dB and 34.97 dB, respectively).

FIG. 8 is a block diagram of exemplary apparatus 900 that may be used to perform operations in a manner consistent with the present invention and/or to store information in a manner consistent with the present invention.

FIG. 9 illustrates a block diagram of an exemplary implementation of embodiments consistent with the present invention.

### §4. DETAILED DESCRIPTION

The present invention may involve novel methods, apparatus, message formats, and/or data structures for improving video distribution, such as video distribution within an infrastructure-based wireless network for example. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

### §4.1 Exemplary Environment in which Embodiments Consistent with the Present Invention May be Used

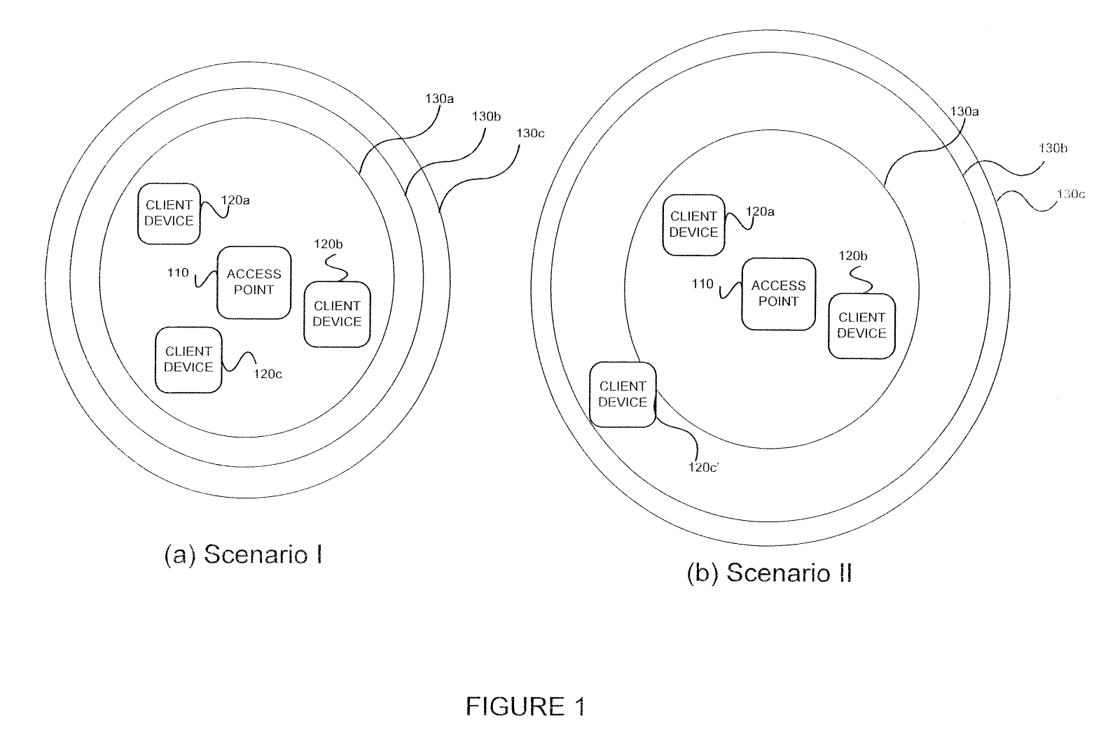

Embodiments consistent with the present invention might be used in a wireless network in which the video server node (e.g. a base station or access point) is multicasting video to distributed multicast receiver nodes within its coverage area. FIG. 1 illustrates examples of wireless networks in which the embodiments consistent with the present invention may be used. In the networks, access point 110 serves as a video server node. Video transmitted by the access point 110 is to be rendered on various client devices 120a-120c (also referred to as “receiver nodes”). The different rates at which an access point 110 transmits video information may vary as shown by elements 130a, 130b, and 130c.

### §4.2 Exemplary Methods

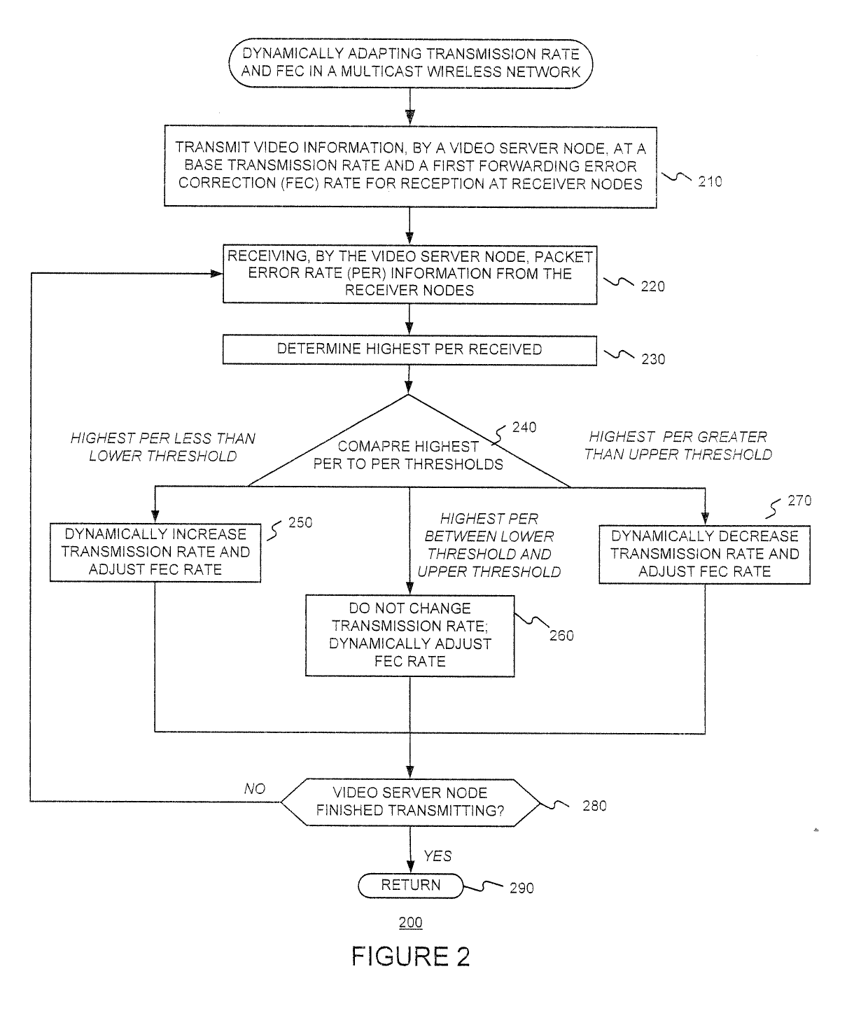

FIG. 2 is a flow diagram of an exemplary method 200 for dynamically adapting transmission rate and FEC rate of video information in a multicast wireless network. A video server node (i.e., access point) may transmit video information at a first transmission rate and a first FEC rate for reception at receiver nodes. (Block 210) Each of the plurality of receiver nodes would then send PER information back to the video server node. (Block 220) The video server node would then determine the highest (i.e., worst) PER received from the receiver nodes. (Block 230) If the video server node determined that the highest PER was less than a lower threshold (i.e., indicating a low number of errors) (Block 240), the video server node would dynamically increase the transmission rate and adjust the FEC rate (Block 250). If the video server node determined that the highest PER was greater than an upper threshold (i.e., indicating a high number of errors) (Block 240), the video server node would dynamically decrease the transmission rate and adjust the FEC rate (Block 270). If the video server node determined that the highest PER was between the lower threshold and upper threshold, (Block 240), the video server node would not change the transmission rate but would adjust the FEC rate (Block 260). After adjusting (Blocks 250 and 270), or not adjusting (Block 260), the transmission rate and FEC rate, the method then determines if the video server node is finished transmitting (Block 280). If the video server node is not finished transmitting, the method returns to Block 220 and receives new PER information from the receiver nodes and proceeds from there. If the video server node is finished transmitting, the method 200 is then left (Block 290).

§4.2.1. Joint Transmission Rate and FEC Adaptation

Although rate adaptation is a standard feature in today's wireless networks, multi-cast/broadcast packets are transmitted using the base transmission rate of the system (e.g., 1 Mbps for IEEE 802.11b). The motivation for using the lowest transmission rate is to enable far away receivers to successfully receive and decode the transmitted packets. In multicast, one cannot rely on retransmission to correct lost packets. Allowing the multicast server to retransmit lost packets to all receivers would dramatically increase the overhead on the network, since each receiver may ask for retransmission of different packets (due to the independent errors at different receivers). Without any other error control mechanism, the server has to transmit at the lowest possible rate in order to accommodate users with poor channel conditions.

Forward error correction (FEC) at the application layer is a promising alternative for handling losses in multicast services. The basic idea of FEC is that redundant information is sent a-priori (i.e., without knowledge that a specific error has occurred) by the source station, in order to be used by the receivers to correct errors/losses without contacting the source. Since CRC-based error detection at the link layer results in the removal of the corrupted packets, many FEC-based protocols try to recover these packets. (See, e.g., L. Rizzo, “Effective erasure codes for reliable computer communication protocols”, in ACM Computer Communication Review, April 1997, incorporated herein by reference.) However, such a scheme introduces overhead since extra parity packets are now transmitted by the source station. The overhead introduced is the number of parity packets to be sent for k source packets. The number of parity packets, m, depends on the Packet Error Rate (PER). Note that, the level of the overhead depends on the packet error rate. P_{E}, in the network. Thus, the higher is the packet error rate, the more the parity packets that must be transmitted by the server, and therefore the more the overhead and the less the FEC rate, γFEC, which is the ratio of source packets to the total number of packets:

$$γ FEC = \frac{k}{k + m} . \qquad ( 1 )$$

In wireless networks, different transmission rates, R_{PHY}, give different PER. Furthermore, due to path loss and fading, for a fixed transmission rate, different PER values can be observed at different locations. Thus, as can be appreciated from the foregoing, the number of parity packets, hence the FEC rate depends on the location and physical transmission rate (i.e. γFEC(1, R_{PHY})).

Note that the FEC overhead is not the only overhead in the system. In order to consider the other overheads (e.g., headers, etc.), the effective data ratio, β, is defined as the ratio of the time spent to transmit the actual payload data to the total transmission time. Since headers are transmitted at different transmission rates, β depends on the transmission rate (i.e. β (R_{PHY})).

Based on the discussion above, the useful rate, Ruseful, can be computed as follows:

R_{useful}=γ_{FEC}(l,R_{PHY})β(R_{PHY})R_{PHY} (2)

In the above formulation, it is not clear how one should define the combination of transmission rate and FEC rate in order to increase the efficiency of the network. On the one hand, the higher the transmission rate is, the higher the PER and therefore the more FEC parity packets should be transmitted. On the other hand, as the transmission rate increases, the more efficient the use of the medium becomes, allowing more room for extra FEC parity packets.

To address this issue, a joint transmission rate and FEC adaptation algorithm to maximize the multicast performance is used. The basic idea behind the proposed system is that all the multicast receivers periodically send PER information to the AP. Based on the received PER information, the AP identifies the highest PER and adjusts the transmission rate and the FEC based on this PER. For a fixed transmission rate, the adjustment of the FEC rate is not a trivial issue due to the dynamic wireless environment. This decision becomes more complicated if the multi-rate capability of existing wireless LAN technology is considered. Note that for a fixed distance, the PER is different for different transmission rates. Hence, while switching from one transmission rate to another, the amount of FEC to be applied should be adjusted. However, when the joint design of transmission rate and FEC is considered, the following should be defined: (A) the PER thresholds that will lead to a change of transmission rate and the corresponding FEC that is needed and (B) the FEC to be applied while the system stays at the same transmission rate for different PER values.

§4.3 Examples Using Embodiments Consistent with the Present Invention

§4.3.1 Example of Per Threshold Determination

There are numerous ways to determine PER thresholds (experimental results, simulation models, predictive algorithms, etc.). In one example, outdoor experiments for an IEEE802.11b based WLAN were conducted and PER values for different transmission rates and various locations were obtained. Then, based on these PER measurements, the amount of FEC using equation (1) and the corresponding useful rate were computed.

PER was measured using “Iperf”, which is a powerful commonly used network testing tool for traffic generation and measurement. In the measurement setup, one of the stations runs an Iperf client to generate User Datagram Protocol (UDP) traffic streams, while the other runs an Iperf server which receives the traffic and collects the statistics (e.g., PER). To remove any random effects and short-term fluctuations, each experiment was run 10 times with each run lasting 1 minute. The results were then averaged.

During the PER measurements, the packet losses due to channel conditions were the primary focus rather than the traffic contention in the channel. The overhead introduced by MAC, IP and physical layer headers is also considered. For further details on the PER measurements, the reader is referred to O. Alay, T. Korakis, Y. Wang, S. Panwar, “An Experimental Study of Packet Loss and Forward Error Correction in Video Multicast over IEEE 802.11b Network”, in Proceedings of IEEE CCNC, 2009, incorporated herein by reference.

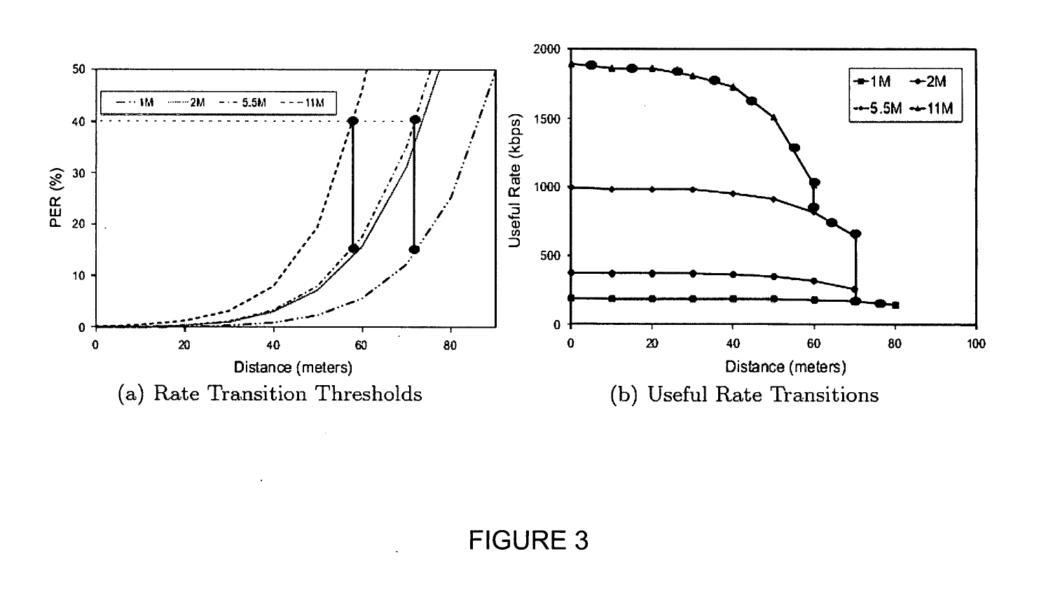

Several experiments were run for different distances between the access point and the receiver. The distance was varied from 10 to 80 meters with the access point and the receiver always within line of sight. In FIG. 3(a), the PER curves are presented for an IEEE 802.11b system at different distances in an outdoor environment for different transmission rates in the broadcast mode. Only the results up to 50% PER are illustrated in FIG. 3(a), since for PER higher than 50% the connection was often lost due to bad channel conditions making the obtained PER values unreliable. FIG. 3(b) illustrates the corresponding useful rates. Note that using a higher transmission rate together with stronger FEC is more efficient than using a lower transmission rate with weaker FEC for video multicast. Following this rule, in the new scheme the highest transmission rate balancing the packet losses is focused on by applying the needed FEC. Note that although 2 Mbps and 5.5 Mbps have different transmission rates, due to different modulation schemes, they have similar PER curves. 5.5 Mbps is directly used in the rate adaptation algorithm instead of using 2 Mbps since it provides higher useful rate. In these figures, at 70 m, transmission can be sustained at 5.5 Mbps with 40% PER or at 1 Mpbs with a PER rate of 15%. In this case, instead of transmitting at 1 Mbps (which has a useful rate of 167 kbps), the system transmits at 5.5 Mbps applying additional FEC (with a useful rate of 647 kbps). Similarly, at 60 m, although transmission rates of 11 Mbps, 5.5 Mbps and 1 Mbps can be sustained, a transmission rate of 11 Mbps is chosen. Note that by doing these transitions, for a given location, rather than operating at the direct transmission rate of 1 Mbps, the system operates at the highest sustainable transmission rate. With this design, the system is able to operate at the highest possible useful rates at all distances, as indicated in FIG. 3(b).

§4.3.2 Example Use of Joint Transmission Rate and FEC Adaptation

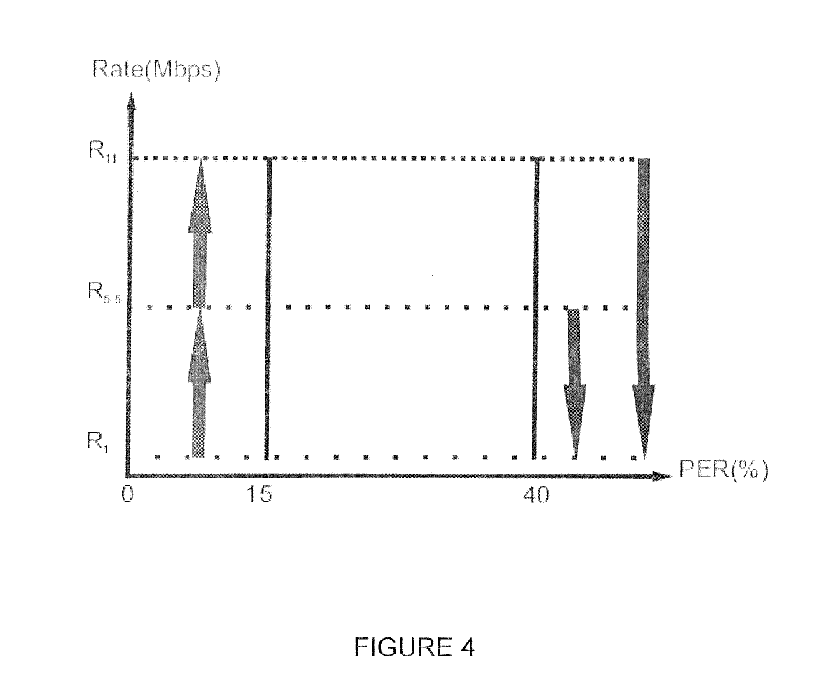

There are several rate adaptation approaches in the literature for the unicast transmission. Although these approaches can be applied to the proposed system, exemplary embodiments consistent with the claimed invention choose to search through different rates, starting from the base rate, to find the optimal solution. In exemplary embodiments consistent with the claimed invention, in order to guarantee that all the multicast clients are covered, the system starts, for example, with the 1 Mbps base rate of IEEE 802.11b, and based on the PER information received from the clients, the system adapts the transmission rate along with the FEC. Of course, in different embodiments, other rates may be used as the base rate. The rate and FEC adaptation algorithm has two components:
1. Switch the Transmission Rate: in FIG. 4, the transmission rate adaptation algorithm used in the system is illustrated. In the figure the arrows indicate the change in the transmission rate. When the PER is between 0 and 15%, the system switches to a higher transmission rate. Note that when a switch is made to a higher transmission rate, since the PER in the previous transmission rate is between 0 and 15%, the PER in the current transmission rate will be less than 40% (see FIG. 3(a)). Hence, while switching to a higher transmission rate, the worst case scenario is considered and PER of 40% is assumed. At any transmission rate, if the PER received is higher than 40%, it is assumed that the current transmission rate cannot be sustained and the system is directly switched to the base rate where a PER of 40% is assumed. For example, if the system currently transmits at 1 Mbps and the PER is between 0 and 15%, the system jumps to a higher transmission rate, 5.5 Mbps and assumes a maximum PER of 40%. If at 5.5 Mbps, the PER is still small (e.g. 0-15%), the system switches to a higher rate and starts to transmit at 11 Mbps assuming PER of 40%. Finally, if the PER received is higher than 40%, the system directly switches to the base rate, 1 Mbps. For 11 Mbps, if the PER is slightly higher than 40%, the system can switch to the next lower transmission rate of 5.5 Mbps.
2. Keep the Same Transmission Rate: Note that in FIG. 4 there are regions in which the transmission rate is not changed. These regions are determined using the experimental results illustrated in FIG. 3(a). In FIG. 4, note that if the PER at 1. Mbps is more than 15%, it may not be efficient to jump to a higher transmission rate since a PER of more than 40% may be observed at 5.5 Mbps.

Note that for different transmission rates and FEC rates, there exist different useful rates. Therefore, while switching between the transmission rates, the system also switches to the corresponding video rate (i.e., useful rate). Furthermore, when the same transmission rate is maintained, the FEC rate is still adjusted based on the PER which leads to different video rates. Different exemplary video rates used in embodiments consistent with the claimed invention are discussed below.

§4.3.3 Results from Examples Using the Proposed Transmission Rate and FEC Adaptation Scheme

The following shows the effectiveness of the proposed system. Two different scenarios are considered:
1. Scenario-I: In the first scenario, the server and the clients are in close proximity, as illustrated in FIG. 1(a).
2. Scenario-II: Server, Client 1 and Client 2 are in close proximity with each other while Client 3 is a mobile user moving around, as illustrated in FIG. 1(b).

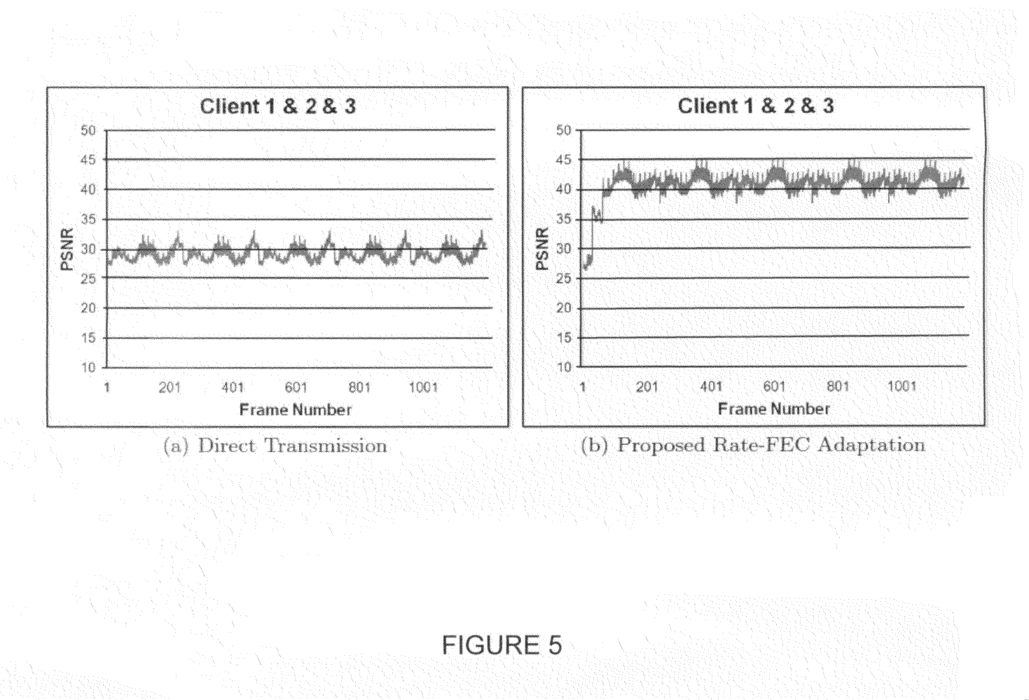

In Scenario-I, the video quality of the proposed system was compared with direct transmission, as illustrated in FIG. 5. In this first scenario, the direct transmission operates in the low PER region of 1 Mbps (i.e. video rate=0.13 Mbps). Even though all clients are close to the access point, since the physical transmission rate is 1 Mbps, the video quality is low, as illustrated in FIG. 5(a). When the proposed algorithm is used, the PER is small since the clients are close to the server. Hence, the video server starts transmitting using 1 Mbps and gradually increases the transmission rate, reaching, 11 Mbps. Compared to direct transmission, the proposed algorithm significantly improves the video quality for all the users, as illustrated in FIG. 5(b). Note that this scenario shows the maximum achievable quality improvement, compared to direct transmission. The proposed rate and FEC adaptation system improves the average PSNR to 40.68 dB for all users, compared to 29.23 dB for all users with direct transmission.

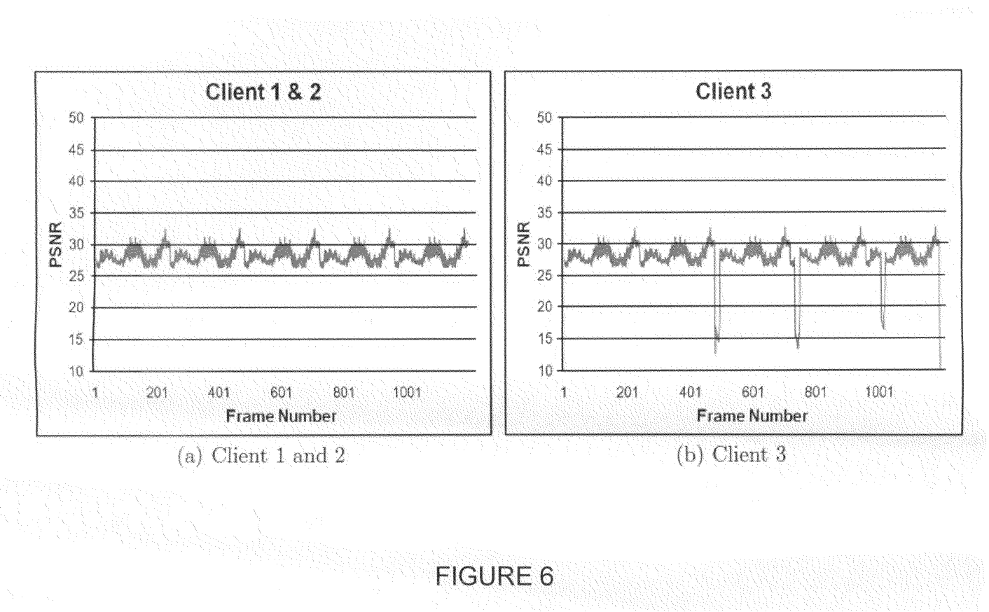

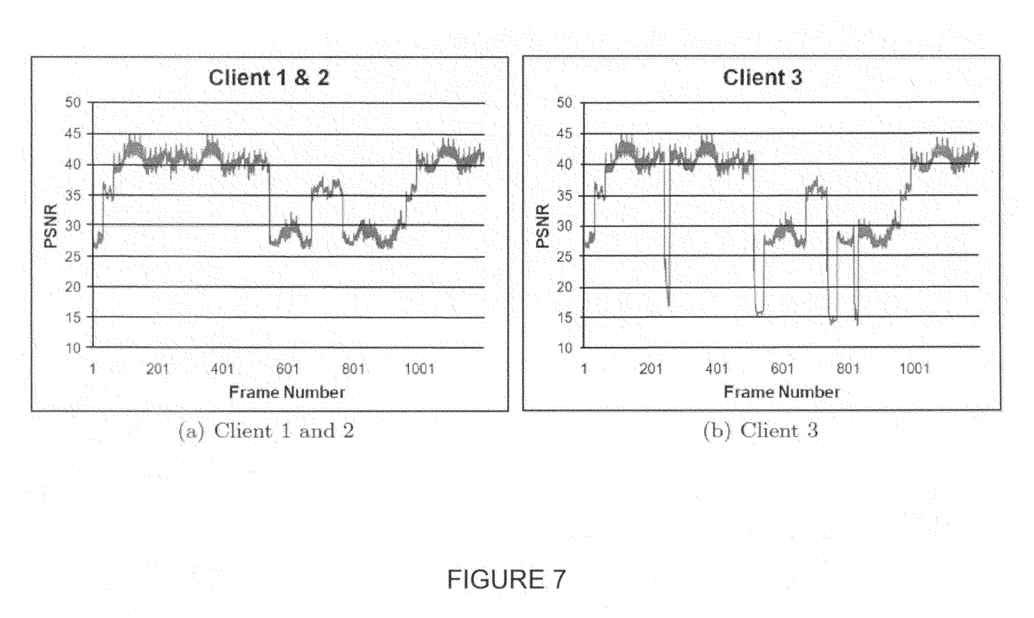

In Scenario-II the video quality of the proposed system is compared with direct transmission, as illustrated in FIGS. 6 and 7. In this scenario, the direct transmission operates in the high PER region of 1 Mbps (i.e. video rate=0.10 Mbps). The video quality in the case of direct transmission is illustrated in FIG. 6. Note that, in this scenario the FEC rate is fixed and chosen based on Client 3. Hence, Client 1 and Client 2 receive more parity packets than necessary and are able to decode all the blocks correctly. However, since the transmission rate is 1 Mbps, the video quality is still low as illustrated in FIG. 6(a). On the other hand, due to the fluctuations in the channel, the applied FEC is occasionally insufficient for Client 3. Hence, there are some blocks which cannot be decoded as depicted in FIG. 6(b). The proposed rate-FEC adaptation system adjusts its parameters based on the worst PER. Whenever the PER is small, the algorithm switches to a higher transmission rate and whenever Client 3 moves away from the server and experiences a higher PER, the proposed system switches to a lower transmission rate (FIG. 7). Client 1 and Client 2 are able to decode all the blocks as presented in FIG. 7(a). Since Client 3 is mobile, it occasionally experiences higher PER than the system predicts. This leads to unrecoverable packets and a sharp drop in the PSNR of Client 3 as depicted in 7(b). Compared to direct transmission, the proposed algorithm provides equal or better quality to all users. The proposed algorithm improves the average PSNR to 36.59 dB compared to 28.31 dB with direct transmission for Client 1 & 2. For Client 3, the proposed algorithm improves the average PSNR to 34.97 dB compared to 27.88 dB with direct transmission.

### §4.4 Exemplary Apparatus

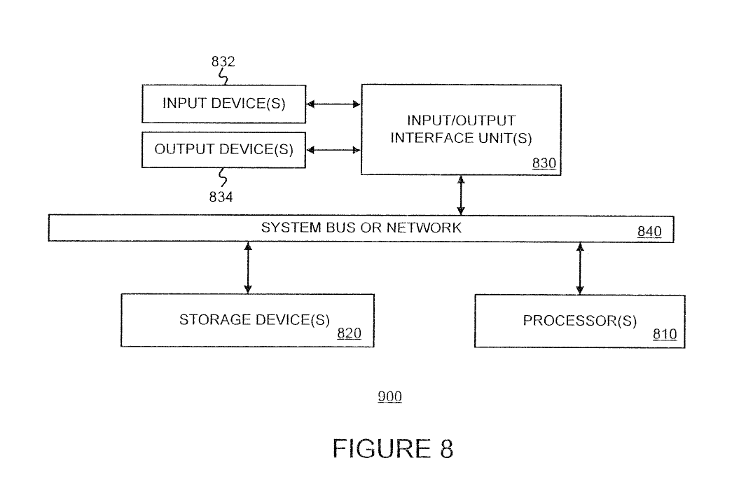

FIG. 8 is a block diagram of exemplary apparatus 800 that may be used to perform operations in a manner consistent with the present invention and/or to store information in a manner consistent with the present invention. The apparatus 800 includes one or more processors 810, one or more input/output interface units 830, one or more storage devices 820, and one or more system buses and/or networks 840 for facilitating the communication of information among the coupled elements. One or more input devices 832 and one or more output devices 834 may be coupled with the one or more input/output 830.

The one or more processors 810 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. For example, one or more software modules, when executed by a processor, may be used to perform one or more of the operations and/or methods of FIG. 2. At least a portion of the machine executable instructions may be stored (temporarily or more permanently) on the one or more storage devices 820 and/or may be received from an external source via one or more input interface units 830.

In one embodiment, the machine 800 may be one or more conventional personal computers or servers. In this case, the processing units 810 may be one or more microprocessors. The bus 840 may include a system bus. The storage devices 820 may include system memory, such as read only memory (ROM) and/or random access memory (RAM). The storage devices 820 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 832, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 810 through an appropriate interface 830 coupled to the system bus 840. The output devices 834 may include a video monitor or other type of display device, which may also be connected to the system bus 840 via an appropriate interface. In addition to the video monitor, the personal computer may include other (peripheral) output devices (not shown), such as speakers and printers for example.

The operations of video server node and client receiver nodes, such as those described above, may be performed on one or more computers. Such computers may communicate with each other via one or more networks, such as the Internet for example. The various operations and information described above may be embodied by one or more machines 800. The servers and/or receivers can be employed in nodes such as desktop computers, laptop computers, personal digital assistants, mobile telephones, other mobile devices, servers, etc. They can even be employed in nodes that might not have a video display screen, such as routers, modems, set top boxes, etc.

Alternatively, or in addition, at least some of the various operations and acts described above may be implemented in hardware (e.g., integrated circuits, application specific integrated circuits (ASICs), field programmable gate or logic arrays (FPGAs), etc.).

### §4.5 Exemplary Implementation of Embodiments Consistent with the Present Invention

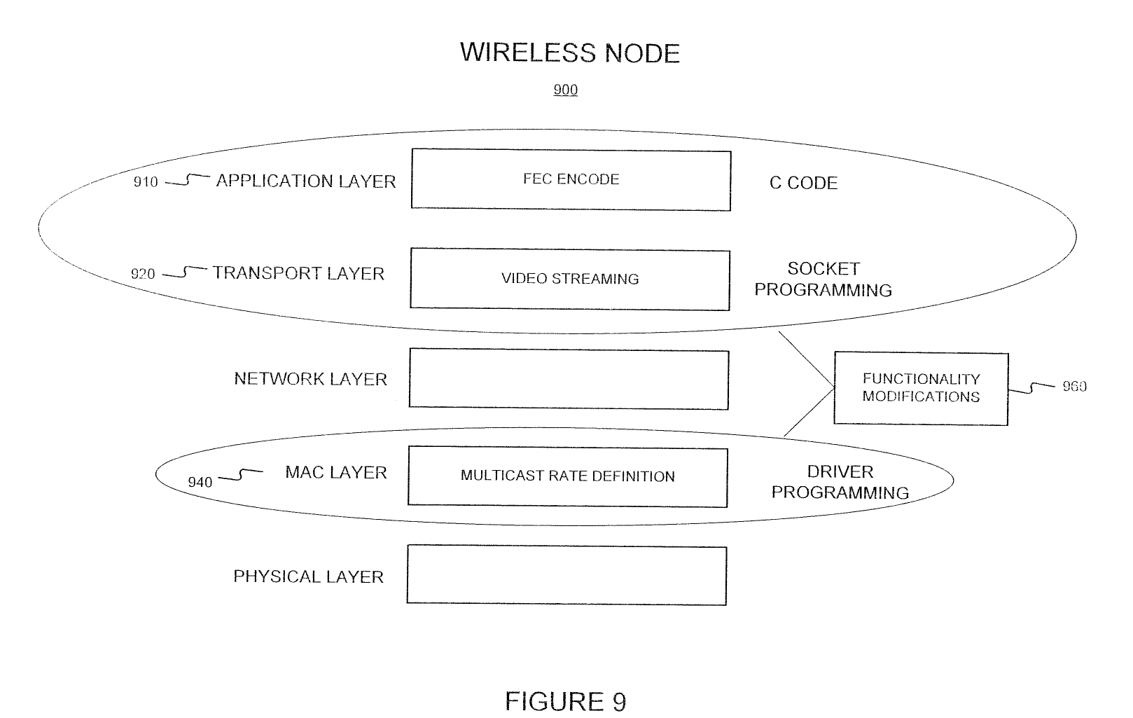

In FIG. 9, an exemplary implementation of embodiments consistent with the claimed invention is depicted. The basic functionality of a wireless node is changed in three different layers of the protocol stack: the MAC, the transport and the application layer. The block diagram of one exemplary system that may be implemented is depicted in FIG. 5. Exemplary features of the system are discussed below.

§4.5.1 MAC Layer

For the implementation of the MAC layer (Blocks 940, 960) open source drivers in a Linux platform is used. In particular the MadWifi driver (described in “MadWifi: Linux kernel drivers for Wireless LAN devices,” http://madwifi.org/, incorporated herein by reference) for the Atheros chip-set (described in “Atheros: Chipsets for Wireless LAN devices,” http://www.atheros.com/, incorporated herein by reference) is used. The driver is used in broadcast mode (i.e. no acknowledgment, no retransmissions). Additionally, a feature in the driver was added which allowed for the selection of the transmission rate that would be used. The wireless cards were set up to work in the 802.11b mode, and therefore four different rates could be chosen: 1 Mbps, 2 Mbps, 5.5 Mbps, 11 Mbps.

§4.5.1 Transport Layer

In order to implement the video streaming service, a video client/server application was built using UDP/IP socket programming (Blocks 920, 960). The server is a program that can read a FEC encoded video file, packetize accordingly and transmit. Similarly, the program in the client side receives packets, does the FEC decoding and stores the resulting video into a file.

§4.5.2 Application Layer

There are two main components in the application layer: Packet Level FEC encoding/decoding (Blocks 910, 960), and feedback generation, each of which is discussed below.

§4.5.2.1 Packet Level FEC

In the application layer a packet level FEC mechanism was implemented. Reed Solomon (RS) codes were utilized since it is one of the well-known block codes with good error correction properties and is widely used in FEC schemes. In general an (n, k) RS code contains k source packets and (n-k) parity packets. Altogether, they form a group of n packets, in a way that any k of the n packets can be used to reconstruct the k source packets. In this work, systematic (n, k) codes, where the first k of the n encoded packets are identical to the k source packets, were used.

In the exemplary implementation described, the generation of the parity packets is done offline. The video with a GOP (Group of Picture) size of 16 frames is first encoded. Note that a GOP always starts with an Intra frame, hence, each GOP is independently decodable. RS(n,k) codes were utilized where parity packets were generated based on the number of the source packets in a GOP. In other words, the number of source packets in each block depends on the number of packets in each GOP, hence k varies for each GOP. While generating the parity packets, it is ensured that enough parity packets for the worst channel conditions were generated. These files were stored in the hard drive of the node in order to use them as inputs on the video streaming server. Note that it would be a waste of bandwidth to send all the parity packets generated since the channel condition is not always bad. Therefore, the number of parity packets to be sent, m, is chosen based on the current channel conditions (i.e. packet error rate PE).

Upon reception of the packets, the receiver decodes the FEC encoded packets, generates the video file and stores it in the node. As long as the number of lost packets is less than m, all original video packets can be decoded successfully. When the loss exceeds the FEC correction limit, all the original video packets cannot be decoded. In this case, only the received video packets are saved into the decoded video files. Finally the quality of the video is obtained using the Peak Signal to Noise Ratio (PSNR) of the received video.

§4.5.2.2 Feedback Generation

The clients compute the PER and send this information to the access point using a reliable connection. The PER is computed and sent once for every two blocks. For each block, the number source packets that were correctly received are reported. Note that only the source packets to compute PER is used since the client does not know how many parity packets were sent. Therefore, the clients count the number of source packets received and compute the PER, which is the ratio of missing packets to all source packets. The access point receives the PER from all clients and can determine the maximum PER. Based on this maximum PER, the access point adjusts its transmission rate and FEC rate. In order to avoid feedback implosion, one can also assign a PER threshold such that clients who have a PER less than this threshold will not send the feedback. In this case, only the clients with bad channel conditions, hence high PER, will send the feedback. In the exemplary implementation described, each client feedbacks the PER periodically. Note that accurate PER estimation is important, as it dictates the number of parity packets to be sent.

### §4.6 Refinements, Alternatives and Extensions

§4.6.1 Standardization Efforts: IEEE802.11AA

The demand for efficient and reliable multicast has recently initiated standardization efforts in the IEEE 802.11 community. The IEEE 802.11aa task group, which kicked off in March 2008, focuses on the robust streaming of audio video transport streams. The discussion topics include, but are not limited to, the Block-ACK generation, scalability and efficient error control. Since exemplary embodiments consistent with claimed invention are based on a feedback channel and also provide error correction, they will also work well within the framework of the 802.11aa standard.

### §4.7 Conclusions

A novel method and apparatus which dynamically adapts the transmission rate and FEC for video multicast over multi-rate wireless networks are described. The method may use, for example, the highest sustainable transmission rate together with a sufficient amount of FEC in order to maximize the video quality of multicast receivers. Exemplary embodiments consistent with the claimed invention show that the described system significantly improves the multicast system performance and that the joint consideration of transmission rate adaptation and FEC adjustment creates a new paradigm for real time multicast transmission over wireless networks.

What is claimed is:

1. For use in a wireless network including a multicast video server node and a plurality of receiver nodes, a computer-implemented method comprising:
a) transmitting, wirelessly by the video server node, video information at a first transmission rate and at a first error correction rate for reception by at least one of the plurality of receiver nodes;
b) receiving, wirelessly, by the video server node, packet error rate information from the at least one of the plurality of receiver nodes to which the video information was transmitted; and
c) adjusting, dynamically by the video server node, at least one of (A) the first transmission rate to a second transmission rate, and (B) the first error correction rate to a second transmission rate, based on the packet error rate received.

2. The computer-implemented method of claim 1 wherein the act of adjusting at least one of (A) the first transmission rate to the second transmission rate, and (B) the first error correction rate to the second transmission rate, based on the packet error rate received includes:
1) determining, by the video server node, the highest packet error rate received from the at least one of the plurality of receiver nodes;
2) determining, by the video server node, whether the highest packet error rate received is one of
(i) less than a first error rate threshold,
(ii) greater then a second error rate threshold, wherein the second error rate threshold is greater than the first error rate threshold, and
(iii) greater than the first error rate threshold and less than the second error rate threshold.

3. The computer-implemented method of claim 2 wherein when the highest packet error rate received is less than the first error rate threshold, adjusting, dynamically by the video server node, both
(i) the first transmission rate to the second transmission rate, wherein the second transmission rate is higher than the first transmission rate, and
(ii) the first error correction rate to the second error correction rate.

4. The computer-implemented method of claim 2 wherein when the highest packet error rate received is greater than the second error rate threshold, adjusting, dynamically by the video server node, both
(i) the first transmission rate to the second transmission rate, wherein the second transmission rate is lower than the first transmission rate, and
(ii) the first error correction rate to the second error correction rate.

5. The computer-implemented method of claim 2 wherein when the highest packet error rate received is both (A) greater than the first error rate threshold and (B) less than the second error rate threshold, adjusting, dynamically by the video server node the first error correction rate to the second error correction rate.

6. The computer-implemented method of claim 2 wherein the first error rate threshold is set at a 15% packet error rate and the second error rate threshold is set at a 40% packet error rate threshold.

7. The computer-implemented method of claim 1 wherein a type of error correction packets transmitted at the first and second error correction rates is Forwarding Error Correction (FEC) parity packets.

8. The computer-implemented method of claim 7 wherein the first and second error correction rates are based on at least (A) a distance of the at least one of the plurality of receiver nodes from the video source node and (B) a physical transmission rate.

9. The computer-implemented method of claim 1 wherein the packet error rate is based on at least (A) a distance of the at least one of the plurality of receiver nodes from the video source node and (B) a physical transmission rate.

10. For use in a wireless network including a multicast video server node and a plurality of receiver nodes, apparatus comprising:
a) at least one processor;
b) a touch sensitive element for receiving finger touch information; and
c) at least one storage device storing program instructions which, when executed by the at least one processor, perform a method including
1) transmitting, wirelessly by the video server node, video information at a first transmission rate and at a first error correction rate for reception by at least one of the plurality of receiver nodes;
2) receiving, wirelessly, by the video server node, packet error rate information from the at least one of the plurality of receiver nodes to which the video information was transmitted; and
3) adjusting, dynamically by the video server node, at least one of (A) the first transmission rate to a second transmission rate, and (B) the first error correction rate to a second transmission rate, based on the packet error rate received.

11. The apparatus method of claim 10 wherein the act of adjusting at least one of (A) the first transmission rate to the second transmission rate, and (B) the first error correction rate to the second transmission rate, based on the packet error rate received includes:
(A) determining, by the video server node, the highest packet error rate received from the at least one of the plurality of receiver nodes;
(B) determining, by the video server node, whether the highest packet error rate received is one of
(i) less than a first error rate threshold,
(ii) greater then a second error rate threshold, wherein the second error rate threshold is greater than the first error rate threshold, and
(iii) greater than the first error rate threshold and less than the second error rate threshold.

12. The apparatus method of claim 10 wherein when the highest packet error rate received is less than the first error rate threshold, adjusting, dynamically by the video server node, both
(i) the first transmission rate to the second transmission rate, wherein the second transmission rate is higher than the first transmission rate, and
(ii) the first error correction rate to the second error correction rate.

13. The apparatus method of claim 10 wherein when the highest packet error rate received is greater than the second error rate threshold, adjusting, dynamically by the video server node, both
(i) the first transmission rate to the second transmission rate, wherein the second transmission rate is lower than the first transmission rate, and
(ii) the first error correction rate to the second error correction rate.

14. The apparatus method of claim 10 wherein when the highest packet error rate received is both (A) greater than the first error rate threshold and (B) less than the second error rate threshold, adjusting, dynamically by the video server node the first error correction rate to the second error correction rate.

15. The apparatus method of claim 11 wherein the first error rate threshold is set at a 15% packet error rate and the second error rate threshold is set at a 40% packet error rate threshold.

16. The apparatus method of claim 10 wherein a type of error correction packets transmitted at the first and second error correction rates is Forwarding Error Correction (FEC) parity packets.

17. The apparatus method of claim 16 wherein the first and second error correction rates are based on at least (A) a distance of the at least one of the plurality of receiver nodes from the video source node and (B) a physical transmission rate.

18. The apparatus method of claim 10 wherein the packet error rate is based on at least (A) a distance of the at least one of the plurality of receiver nodes from the video source node and (B) a physical transmission rate.
